(19) United States
(12) Patent Application Publication
(10) Pub. No.: US 2016/0249090 A1
(43) Pub. Date: Aug. 25, 2016

(54) SOCIAL NETWORK BASED ENHANCED CONTENT VIEWING

(71) Applicant: Microsoft Technology Licensing, LLC, Redmond, WA (US)

(72) Inventors: Curtis G. Wong, Medina, WA (US); Dale A. Sather, Seattle, WA (US); Kenneth Reneris, Redmond, WA (US); Thaddeus C. Pritchett, Edmonds, WA (US); Talal A. Batrouny, Sammamish, WA (US)

(21) Appl. No.: 15/147,250

(22) Filed: May 5, 2016

Related U.S. Application Data
(63) Continuation of application No. 11/767,338, filed on Jun. 22, 2007.

(51) Int. Cl. H04N 21/435; H04N 21/2747; H04N 21/235; H04N 21/4788; H04N 21/466; H04N 21/242; H04N 21/43; H04N 21/81; H04N 21/4147; H04N 21/6587

(52) U.S. Cl. CPC H04N 21/435; H04N 21/4147; H04N 21/2747; H04N 21/235; H04N 21/6587; H04N 21/466; H04N 21/242; H04N 21/4307; H04N 21/8133; H04N 21/4788

(57) ABSTRACT

The disclosure relates to an enhanced user media viewing experience in a shared viewing environment. A content sharing system is provided in which one digital video recording device controls the presentation of the same video content and optionally the acquiring of that video content on disparately located digital video recording devices. Various communications devices (e.g., VOIP devices, web cameras, instant messaging, etc.) are used to facilitate interactions between viewers at the disparately located locations. User-generated commentary, whether live via the communication devices or pre-recorded, is presented while a viewer is viewing a particular piece of video content and can be synchronized to be presented at a particular time in the video.

### CROSS-REFERENCE TO RELATED APPLICATION

The present application is a continuation of and claims priority of U.S. patent application Ser. No. 11/767,338, filed Jun. 22, 2007, the content of which is hereby incorporated by reference in its entirety.

### TECHNICAL FIELD

This disclosure is related to enhancing a user media viewing experience by sharing the experience of viewing video content with others, such as in real-time or via prerecorded commentary.

### BACKGROUND

Americans are no longer satisfied with merely watching content, such as a television program or a movie. They want to participate in the experience and/or share their experience with others, whether by sitting down and enjoying television with friends and loved ones or by providing commentary to extended acquaintances. Unfortunately, with more Americans moving from place to place, it has become difficult to sit down and enjoy television programs together in one location. For example, time zone differences may prevent simultaneous live viewing of the same television program by a son in Washington with his parents in New Jersey.

Furthermore, with the advent of the Internet, people expect to be able to discuss a television program episode during and after the episode airing on live television. In order to facilitate the discussion, many forums and email lists are devoted to each popular show, including official forums maintained by the studios producing the shows or the stations that broadcast the television show. Viewers have also resorted to remixing recorded version with their own commentary and posting the remixed versions on user-generated video sites, such as YouTube.

However, these types of interactions suffer from a number of problems. For example, these interactions are not well integrated into the traditional viewing experience and are not flexible enough to be personalized for small groups of people. For example, most user-generated videos must be downloaded on a broadband connection and viewed on the computer, not the larger television. Typing comments in a forum can be distracting while simultaneously viewing the original airing. In addition, some things would be lost in translation when widely distributed, such as inside jokes or references to a particular person or experience. Privacy concerns can prevent some people from sharing their experience over the Internet. Other types of video content, such as infomercials and advertisements, often do not have forums and email lists associated with them. Finally, these types of interactions generally require viewing users to have some degree of technical expertise, as a single technical user cannot remotely control presentation devices.

The above-described deficiencies are merely intended to provide an overview of some of the problems of today's interactive viewing techniques, and are not intended to be exhaustive. Other problems with the state of the art may become further apparent upon review of the description of various non-limiting embodiments of the invention that follows.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

According to one aspect of the invention, a content sharing system is provided that allows a user to select and control video content for viewing at different locations via digital video recorders (DVRs). Commands, such as pause, fast forward, rewind, replay, skipping commercials, can be executed across all DVRs to ensure the same viewing experience. Various communications means, such as web cameras and VoIP devices, can be used for real-time communication between the different locations so as to mimic the experience of sitting in a single room and watching the video content together. Content can be synchronized using on-screen events or hashes of the video content to prevent another user communicating in real-time from spoiling the moment because of slight differences in timing (e.g. due to differences in commercial length). Recording can also be remotely controlled in some embodiments and difference in the various locales (time zone, channel number, etc.) are taken into account. Once the content is recorded, a user can subsequently send a request that prompts respective DVRs in disparate locations to play the same content at the same time.

According to another aspect of the invention, an enhanced content viewing system is provided that allows user to view user-generated content about the video content while simultaneously viewing that video content via a DVR. The user-generated content, which is not part of the original video content, is integrated into the user experience, such as by playing a user-generated audio track instead of or mixed with the original audio track for the video content and/or displaying scrolling text above or below the picture. The user-generated content can be produced in real-time via remote communication devices or pre-recorded and made available to the DVR in advance, such as via the Internet. Hashes and offsets from on-screen events (e.g., the end of the commercial break, a blank frame between scenes, etc.) can be used to synchronize the user-generated content to the video content currently being displayed.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a schematic block diagram of an exemplary computing environment.

FIG. 2A depicts a block diagram of exemplary components and devices at a controlling location according to one embodiment.

FIG. 2B depicts a block diagram of a component containing an artificial intelligence engine.

FIG. 3 depicts a block diagram of exemplary components and devices at a remote viewing location according to one embodiment.

FIG. 4 depicts an exemplary screen on a video presentation device during presentation of the video content.

FIG. 5 is an exemplary flow chart of the controlling digital video recorder according to one embodiment.

FIG. 6 depicts an exemplary flow chart of the controlling digital video recorder during playback of a piece of video content.

FIG. 7 is an exemplary flow chart of the controlled digital video recorder according to one embodiment.

FIG. 8 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, unless specified otherwise or clear from the context, “disparate locations” means two different locations that are not located within the same the household or office. Video content can include, but is not limited to, television programs, movies, and advertisements. The video content can be acquired in various manners, such as recorded off a live broadcast (e.g., over the air, cable, satellite), downloaded over the Internet (e.g., from user-generated video sites), purchased/leased from conventional distribution channels (e.g., DVDs, video tapes, Blu-Ray disks, etc.). The video content can also be of various formats and resolutions including standard definition, enhanced definition, or high definition (720p, 1080i or 1080p).

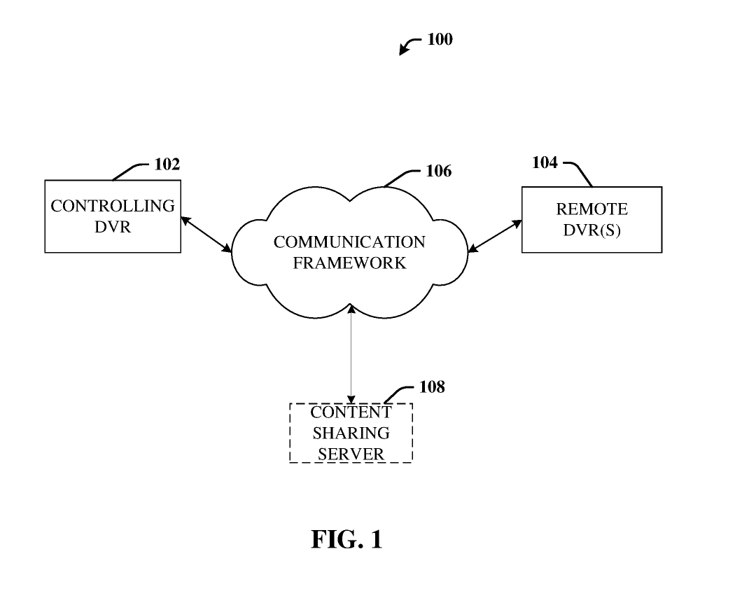

Referring now to FIG. 1, there is illustrated a schematic block diagram of an exemplary environment 100 in which a shared content viewing experience occurs. For the sake of simplicity and clarity, only single type of each location is illustrated. However, one will appreciate that there can be multiple locations of some types (e.g., the remote viewing location). In addition, one will also appreciate that a single location can act as a controlling viewing location for one shared experience and as remote viewing locations for other shared experiences.

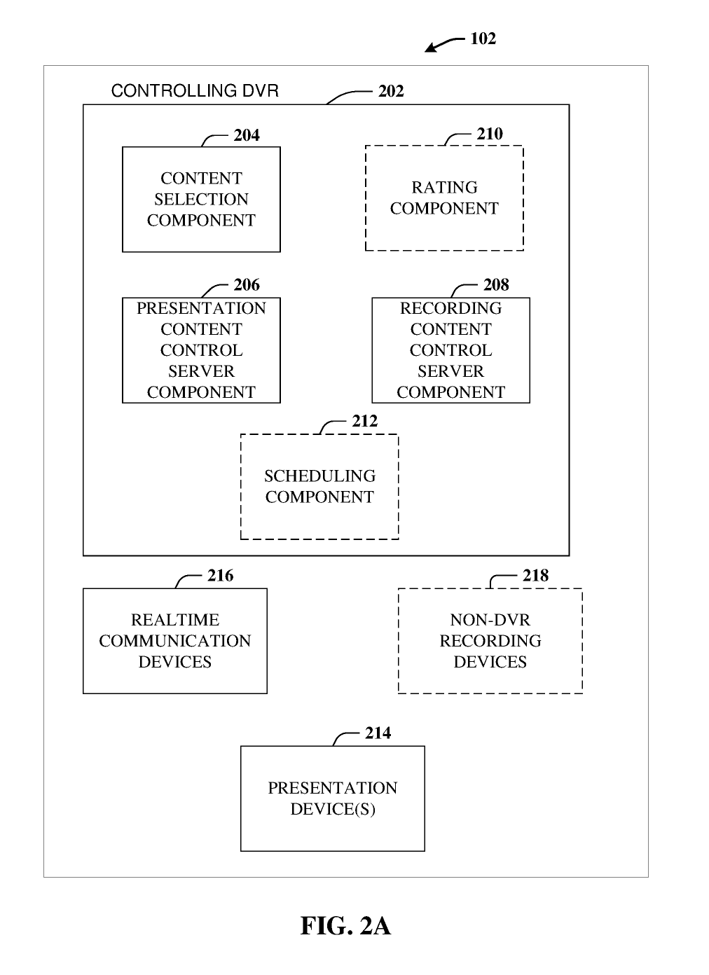

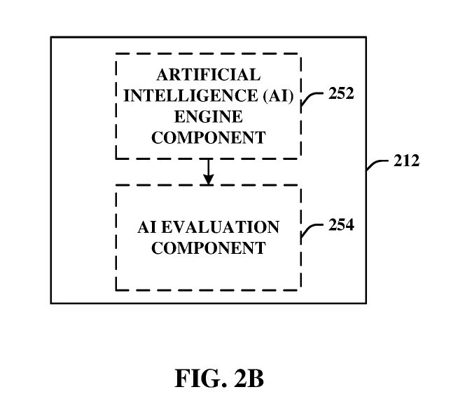

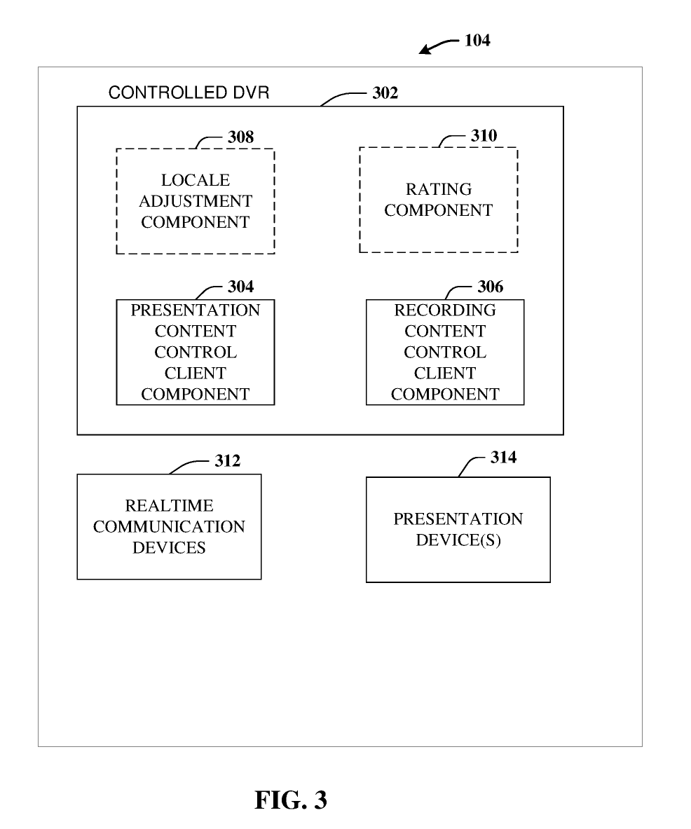

The environment 100 includes a controlling viewing location 102, one or more remote viewing locations 104, a communication framework 106, and optionally a content sharing server 108. The controlling viewing location 102 can control the playback and, in some embodiments, the recording of content at the remote viewing locations 104. Additional details about the controlling viewing location 102 are discussed in connection with FIG. 2A. At the remote viewing location 104, the same piece of video is presented as at controlling viewing location 102. Additional details about the controlling viewing location 102 are discussed in connection with FIG. 3. In order to facilitate the control of playback (and optionally recording), the controlling viewing location 102 is connected to the remote viewing location via the communication framework 106.

In some embodiments, a content sharing server 108 facilitates the shared viewing environment. For example, the content sharing server can provide video content (e.g., advertisements, pilots, short clips, episodes without commercials), with or without fee to the users, to share. In addition, the content sharing server can collect various statistics about the use of the system. Various web-based applications can be implemented on the content sharing server to facilitate use of the shared viewing environment. By way of example, a web-based application can be implemented to: assist in determining a time with family and friends to watch the video content together; run incentive programs for sharing certain content (e.g., commercials, new series); facilitate permissions to control respective DVRs; or provide prerecorded user-generated content, such as commentary.

The communication framework 106 (e.g., a global communication network such as the Internet, the public switched telephone network) can be employed to facilitate communications between the controlling viewing location 102, remote viewing locations 104, and the content sharing server 108, if present. Communications can be facilitated via a wired (including optical fiber) and/or wireless technology and via any number of network protocols.

One possible communication between the controlling viewing location 102 and a remote viewing location 104 can be in the form of data packets adapted to be transmitted between the two locations. The data packets can include requests for setting up a shared content viewing environment for simultaneous viewing of live or previously recorded content, authentication requests, and control commands. In addition, in some embodiments, the video content itself can be transmitted from the controlling viewing location to the remote viewing location in advance of the enhanced viewing experience.

Referring to FIG. 2A, FIG. 2A illustrates exemplary devices and components at the controlling viewing location 102 according to one embodiment. The illustrated controlling viewing location 102 includes a controlling digital video recording device 202, one or more presentation devices 214, realtime communication devices 216, and optionally non-DVR recording devices 218. Presentation devices 214 include, but are not limited, to televisions, projectors, speakers (audio only), etc. The presentation devices present the video and its associated audio to the viewers.

The realtime communications devices allows viewer in disparate locations to communicate in substantially realtime. The devices can be full-duplex or half-duplex. The realtime communication devices 216 and the non-DVR recording devices 218 can be connected to the controlling DVR 202 or act as standalone helper communication devices. The devices can include, but are not limited, to VoIP devices (e.g., phones/softphones), web cameras, microphones, computers with instant message/text-based chat capabilities, conference calls, etc. The non-DVR recording devices can record viewer's comments for presentation with a future viewing, such as when everyone cannot gather to watch the video content simultaneously.

The controlling DVR 202 comprises a content selection component 204, a presentation control server component 206, a recording content server component 208, a rating component 210, and a scheduling component 212. In order to avoid obscuring the content sharing system, other components that provide basic digital video recording functionality are not shown. The components can be implemented in hardware and/or software.

The content selection component 202 allows a controlling user to select remote viewers to share a selected piece of video content. The selected piece of video content can be previously recorded, on live, or a piece of video content to be recorded in the future. By way of example, the content selection component 202 can implement a user interface, such as a screen displayed on a presentation device 214 to allow the controlling user to select remote users and either a previously recorded program or an upcoming program from an electronic program guide.

A presentation content control server component 206 that allows the controlling user to control playback of the video content across disparately located DVRs by interacting with presentation control client components on the disparately located DVRs. In addition to initiating playback at the disparately located DVRs, the presentation content control server component 206 can also execute various commands, such as rewind, fast forward, commercial-skip, pause, replay, etc. and initiate the realtime communications device. In addition, in some embodiments, the presentation content control server component 206 can distribute user-generated content, such as locally generated user-generated content via the realtime communication devices 216 if those devices are connected to the DVR. In addition, in some embodiments, the presentation content control server component 206 can also tune a disparately located DVR to an indicated video program to enable a shared viewing experience for live television, as oppose to only presenting previously recorded content.

In other embodiments, a user-generated content component (not shown) can initiate using the non-DVR recording device 218 while simultaneously presenting an indicated piece of video content. User-generated content, such as commentary, can then be recorded for people that cannot watch the shared experience with everyone else. In addition, the user-generated component can make the user-generated content available to others for non-live playback, such as by uploading the user-generated content to the content sharing server 108 or distributing the user-generated content directly to the disparately located digital video recorder.

The recording content control server component 208 controls recording content on the disparately located DVRs for future playback within the shared viewing environment. By way of example, the recording can be controlled by interacting with remote recording content control clients on the disparately located DVRs. In other embodiments, the controlling DVR can record the video content normally and then distributes it to the other DVRs as appropriate using another component (not shown). For example, this functionality can be useful when the program has already aired in one time zone and can instead be captured during a rebroadcast in another time zone. More generally, an acquiring component can acquire the video content so that all the DVRs that will participate in the shared viewing experience have the same main content. The rating component 310 allows viewer to rate the program and share those ratings as part of the user-generated content control.

The scheduling component 212 facilitates scheduling a time for the shared experience. In some embodiments, the scheduling component interacts with other software (not shown), such as a local calendar program (e.g., Outlook, Sunbird, etc.) on a computer (e.g., desktop, laptop, or mobile device) (not shown) or a Web based scheduling program (e.g., on the content sharing server 108). The scheduling component 212 can confirm that the viewers are all ready just prior to the showing. The scheduling component 212 can also handle messages that a viewer is running a few minutes late by communicating that to other viewers. In some embodiments, the scheduling component 212 can interact with the presentation control client component on a disparately located DVR to catch a late viewer up with other viewers. For example, it can instruct the presentation control client component to present the video content at a faster speed to catch the viewer up. Audio can be muted or also presented at the faster speed.

The subject invention (e.g., in connection with various components) can optionally employ various artificial intelligence based schemes for automatically carrying out various aspects thereof. Referring to FIG. 2B, some of the functionality of the scheduling component 212 can be implemented using artificial intelligence. Specifically, artificial intelligence engine and evaluation components 252, 254 can optionally be provided to implement aspects of the subject invention based upon artificial intelligence processes (e.g., confidence, inference). For example, the scheduling component can use artificial intelligence to determine whether to play the audio when presenting the video at a faster speed. The use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated by the AI engine 252.

Other implementations of AI could include alternative aspects whereby, based upon a learned or predicted user intention, the system can perform various actions in various components. For example, the system can indicate a time remote viewers are not available, learn when to record/share high definition video content versus standard definition television or learn appropriate manner in which to provide video content and/or user-generated content for a particular remote viewing location. In addition, an optional AI component could automatically determine the appropriate presentation device to present the content on if multiple ones are available. Moreover, AI can be used to determine the audio track (e.g, the language of the audio track, user-generated audio content) to be currently presented with the video content when multiple audio tracks are available.

One will appreciate that although the various components of the system are illustrated as part of the digital video recorder, in other embodiments the components can be part of other devices providing digital video recording functionality, such as a media center computer or built into a television or set-top box. In still other embodiments, a mobile device, such as a laptop or a smartphone, includes some of the illustrated components and is used to control the presentation of the video content.

Referring to FIG. 3, the devices and components at an exemplary remote viewing location 104 are illustrated. The illustrated remote viewing location 104 includes a controlled digital video recording device 302, one or more presentation devices 314 and realtime communication devices 312. The presentation devices present the video, along with user-generated content about the video, to the remote viewers. The presentation devices can be different from those at the controlling viewing location 102. The realtime communication devices 312 can be connected to the controlled DVR 202 or act as standalone helper communication devices. The devices can include, but are not limited, to VoIP devices (e.g., phones/softphones), web cameras, microphones, computers with instant message/text-based chat capabilities, etc. These devices can be the same devices as at the controlling viewing location 102 or different devices.

The controlled DVR 302 comprises a presentation control client component 304, a recording content client component 206, and optionally a locale adjustment component 308 and a rating component 310. In order to avoid obscuring the content sharing system, other components that provide basic digital video recording functionality are not shown. The components can be implemented in hardware and/or software.

The presentation content control client component 304 initiates the presentation of the video content on the presentation device 314 and executes commands received from the controlling DVR via the presentation content server client component 206. In some embodiments, the presentation control client component 304 also automatically turns on the presentation device 314 to initiate viewing. The presentation content control client component 304 also presents user-generated content as appropriate. In addition, the presentation content control client component 304 can initiate or provide indications to initiate using the realtime communication devices 312 to communicate between the different locations. The recording content control client component 306 More generally, the recording content control client component 306 can be a component that acquires video content on behalf of the remote user. By way of example, video content can be downloaded via the Internet from video movie services (a la iTunes Video, Amazon Unbox, or MovieLink), downloaded from other DVRs, acquired from a computer readable storage medium (e.g., a DVD, Video CD, HD-DVD, etc.). Recorded user-generated content about the video content can similarly be acquired.

The rating component 310 allows viewer to rate the program and share those ratings as part of the user-generated content. The locale adjustment component 308 adjusts the system for the local area. By way of example, the locale adjustment component 308 can: determines the correct time for the local time zone and channel to record the video content, select the correct language to view the show in (if multiple languages are available), resize or transcode video as needed to display on the presentation device. The locale adjustment component 308 can also determine an appropriate time to display the user-generated content so as to synchronize with the content currently being displayed and prevent spoiling any surprises. By way of example, this may be achieved using hashes of the video being displayed or a time differential from an event in the video, such as the end of a commercial break or a blank screen between scenes.

In other embodiments, devices and components can be organized in other manners. By way of example, a single location (e.g., a home or office) can have multiple DVRs within it connected to a local network. In this case, the controlling DVR can interact with a single DVR within that network, such as the one that is not busy recording or the one a remote viewer is in front of. In some embodiments, the remote viewing location can comprise a mobile device (e.g., cell phone, smartphone, and laptop) as a presentation device. A peer-to-peer portable device (e.g., a text messaging/instant messaging device) can also be used to present some of the user-generated content. A properly formatted version (e.g., compressed, optimized for the smaller screen size, etc.) of the video content can then be streamed to the mobile device by the controlling DVR. Additional components providing additional functionality can also be utilized in other embodiments, such as a permissions/authentication component to give permission to remote users to record and control the controlling DVR and/or a parental control component can determine what friends' content can be shared with and the type of content that can be shared. In addition, the state of a viewer can be identified and conveyed to the controlling user and/or other viewers. For example, if a viewer needs to a break to get food or use the restroom, the controlling user can be signaled so the video content can be paused at all the locations. One will also appreciate that a single DVR can be utilized as a controlling DVR or controlled DVR as the circumstances warrant.

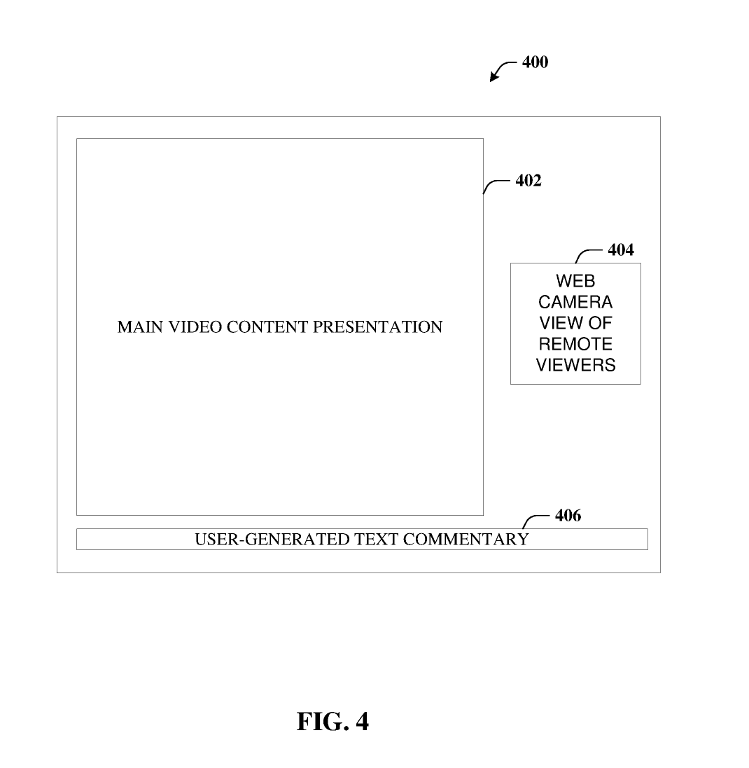

Referring to FIG. 4, an exemplary display of the video content, as well as user-generated content, is depicted. The screen 400 comprises a main video content presentation area 402, a web camera view 404, and user-generated text commentary 406. The main video content presentation area presents the original video content adjusted to fit within the supplied area. The web camera view 404 presents video generated via a web camera at remote locations. In some embodiments, instead of having multiple web camera views, the views can be rotated or synchronized to a location with current audio commentary being presented. The user-generated text commentary 406 can display scrolling text from various viewers. As previously discussed, the commentary can be delayed and triggered after certain on-screen events (e.g., return to the main content after a commercial, a change of scene, etc.) have occurred to prevent spoiling the surprise.

One will appreciate that various other manners and layouts of presenting user-generated content can be used in addition to or instead of the depicted display. For example, the layout will depend on the type of devices used to supply the user-generated content (e.g., whether a web camera feed is available and how many). In addition, the layout of the video content can be modified via the controlled DVR in some embodiments to adjust for the viewer's preferences and/or viewer's presentation devices (e.g., wide-screen TV vs. standard TV). In some embodiments, a user can be prompted for the recorded user-generated content to present while simultaneously presenting the main video content. Furthermore, although not shown, user-generated audio content can also be presented in some embodiments. By way of example, a user-generated audio track can be mixed with or played instead of the original audio track of the video content. In other embodiments, the audio track may be presented on separate devices from the primary presentation device, such as a VoIP device (e.g., a VoIP telephone), computer monitor, secondary television, etc.

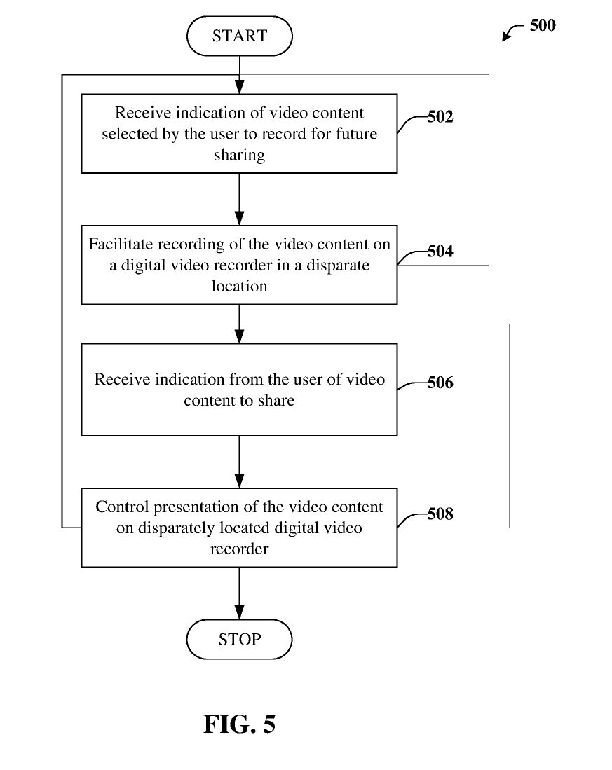

FIGS. 5-7 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use on behalf of a single user for a single piece of video content, the method may be performed for multiple users and/or multiple pieces of video content.

Referring now to FIG. 5, an exemplary method 500 of the controlling DVR is depicted. At 502, an indication is received of video content selected by the user for future sharing. At 504, recording of the selected video content on remote DVRs is facilitated. For example, the controlling DVR can communicate the video content to record taking into account the locale (e.g., timezone, language, channel lineup) of the controlled DVR(s). At 506, an indication is received from the user of video content to share, such as the previously recorded video content. At 508, the presentation of the video content on the disparately located digital video recorder is controlled. Various commands, such as rewind, fast forward, or commercial-skip, can be executed during the controlled presentation.

Although not shown, additional acts can be performed in some embodiments. By way of example, permission can be requested to record video content or control a presentation. Authentication can be used to ensure the identity of the controlling user. As a second example, indications can be transmitted to the content sharing server 108 as part of its incentive programs or for statistics on the use of the system.

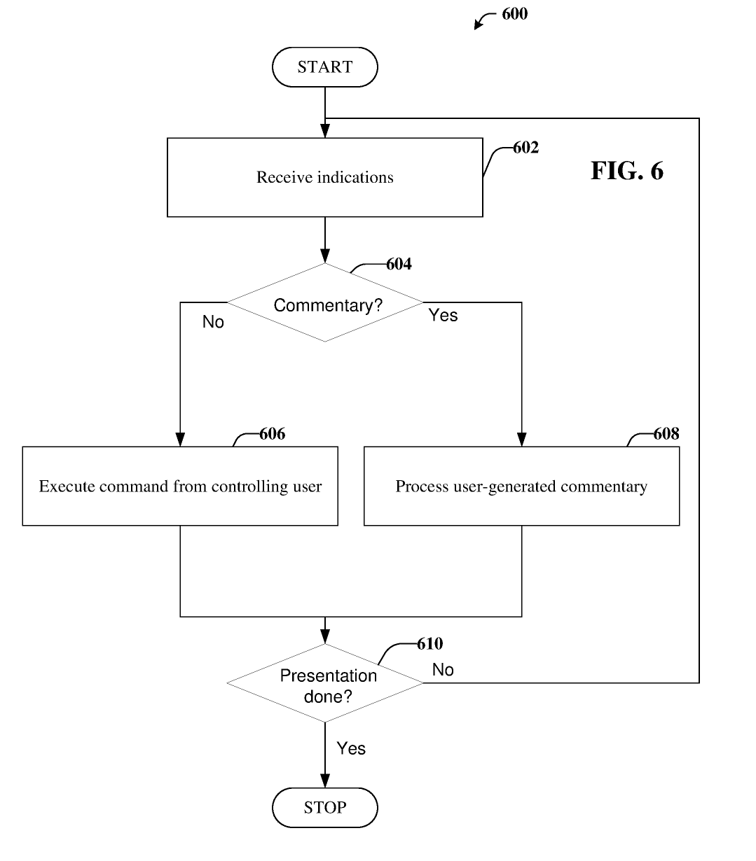

Referring now to FIG. 6, an exemplary method 600 of controlling presentation of video content on disparately located digital video recorders, such as at 508, is depicted. At 602, indications are received. At 604, it is determined if the indications are commentary. If so, at 608, the commentary is processed. The processing can include sending the commentary to the remote viewing location or displaying commentary received from the remote viewing locations. As previously discussed, in other embodiments, some or all of the commentary can be transmitted to or received from the remote location via helper communication devices. If at 604, it is determined that the indication is not commentary, at 606, a command, received as the indication, from the controlling user is executed on the remote digital video recorders. After 606 or 608, at 610, it is determined if the presentation of the video content has ended. If so, the method stops and if not, the method returns to 602 to receive additional indications.

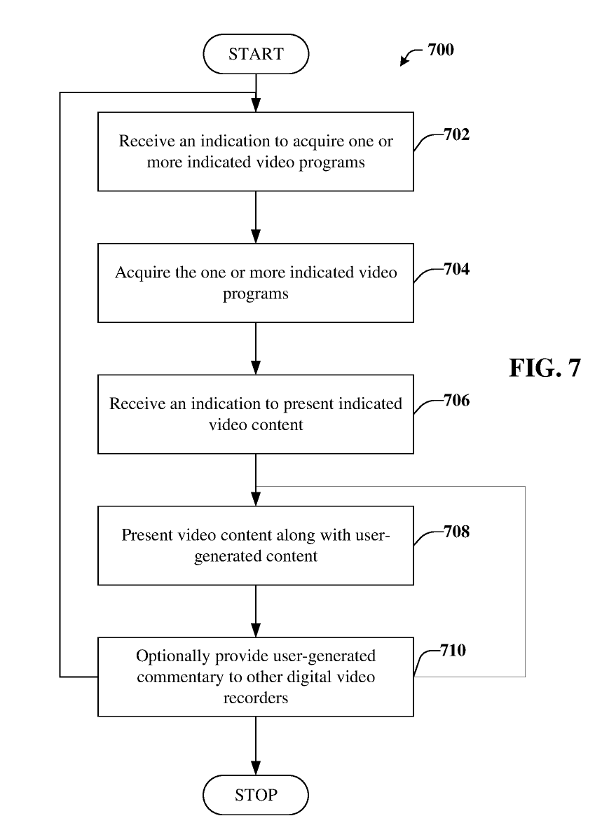

Referring now to FIG. 7, an exemplary method 700 is depicted of a controlled digital video recorder according to one embodiment. At 702, an indication is received to acquire one or more indicated video programs. At 704, the indicated video programs are acquired. For example, each video program can be acquired by recording the video program during a live broadcast of the video program. In other embodiments, some or all of the video programs can be acquired in other manners. For example, a video program can be downloaded over the Internet from a video service, ripped from a DVD (or other computer readable storage media), and/or downloaded from other DVRs (e.g., the controlling DVR). At 706, an indication is received, such as from a desperately located controlling DVR, to present indicated video content on the controlled DVR. At 708, the video content is presented to the viewer, such as via a television connected to the controlled DVR. In addition, user-generated content, if any, can also be presented simultaneously with the video content. Commands, such as pause, commercial-skip, fast forward, etc. can be executed in accordance with commands received from the disparately located controlling DVR. At 710, user-generated commentary is optionally provided other digital video recorders. One will appreciate that content is not provided to other digital video recorders if communication devices that produce user-generated content are not currently providing content (e.g., the communication devices don't exist, are offline, or no content is being generated) or if the content is presented and distributed by helper devices, such as a desktop computer or a VoIP device.

One will appreciate that methodology similar to that of the controlled DVR can also be used for asynchronous, non-remotely controlled viewing of the video content with user-generated content, such as user-generated commentary.

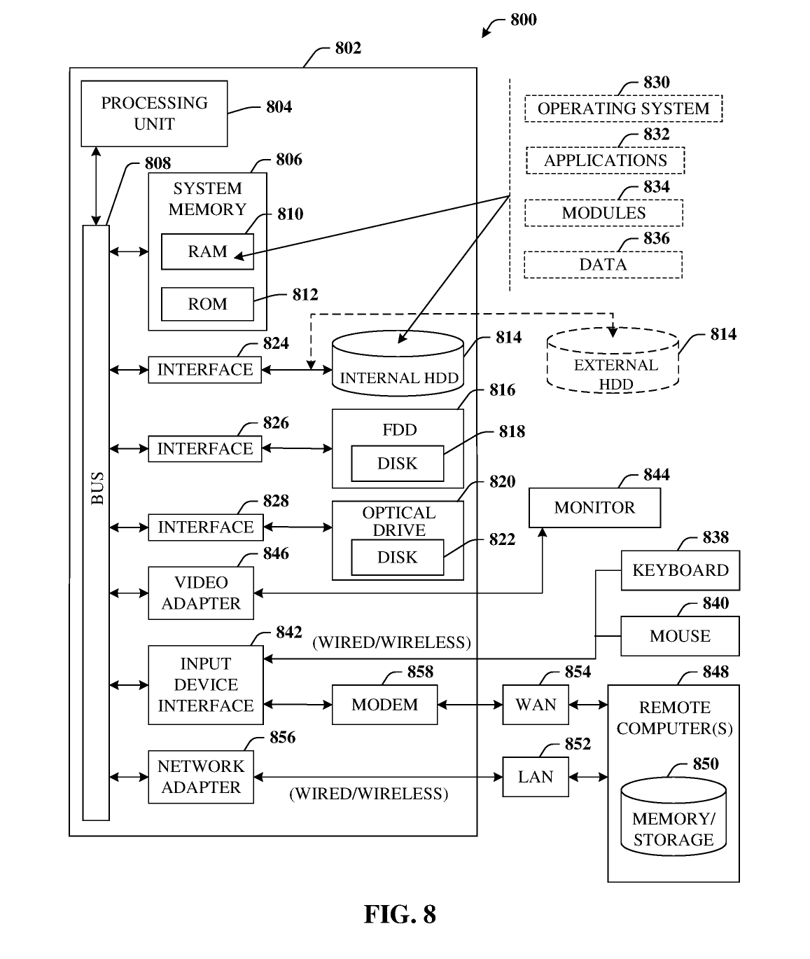

Referring now to FIG. 8, there is illustrated a block diagram of an exemplary computer system operable to execute one or more components of the disclosed allocation system. In order to provide additional context for various aspects of the subject invention, FIG. 8 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network. In at least one embodiment, a distributed computing environment is used for the allocation system in order to insure high-availability, even in the face of a failure of one or more computers executing parts of the allocation system. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the invention includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1384 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a remote computers, such as a remote computer(s) 848. The remote computer(s) 848 can be a workstation, a server computer, a router, a personal computer, portable computer, microprocessor-based entertainment appliance, a peer device or other common network node, various media gateways and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A content sharing system comprising:
a selection component configured to receive an indication of a user selection, from a user, of a particular video content for viewing;
a playback synchronization component configured to communicate with a plurality of disparately located digital video devices through a communication network using a processing unit, the playback synchronization component being configured to:
receive a first playback command input from the user to initiate synchronized playback of the particular video content across the plurality of disparately located digital video devices, and, in response to the first playback command input, send a first playback signal to each of the plurality of disparately located digital video devices over the communication network to initiate the synchronized playback of the particular video content on each of the plurality of disparately located digital video devices; and
during the synchronized playback of the particular video content, receive a second playback command input from the user, and, in response to the second playback command input, send a second playback signal to each of the plurality of disparately located digital video devices over the communication network to control the synchronized playback of the particular video content on each of the plurality of disparately located digital video devices; and
at least one communication device configured to obtain user-generated textual content that is not part of the particular video content, wherein the at least one communication device is configured to transmit the user-generated textual content to the plurality of disparately located digital video devices during the synchronized playback.

2. The content sharing system of claim 1, wherein the communication network comprises a wide area network, and wherein the at least one communication device is configured to transmit the user-generated textual content to the plurality of disparately located digital video devices over the wide area network for rendering during the synchronized playback.

3. The content sharing system of claim 1, and further comprising an input device configured to receive an input from the user and to generate the user-generated textual content based on the received input.

4. The content sharing system of claim 3, wherein the user-generated textual content comprises content about the particular video content, and wherein the user-generated textual content is transmitted over the communication network to the plurality of disparately located digital video devices for rendering during the synchronized playback.

5. The content sharing system of claim 4, wherein, during the synchronized playback, the user-generated textual content is displayed to another user along with the particular video content.

6. The content sharing system of claim 5, wherein display of the user-generated textual content is synchronized to the particular video content based on an on-screen event or hash of the particular video content.

7. The content sharing system of claim 5, wherein the user-generated textual content comprises user commentary on the particular video content.

8. The content sharing system of claim 4, wherein the generation, transmission, and rendering of the user-generated textual content occurs in real-time.

9. The content sharing system of claim 1, wherein the second playback signal comprises at least one of:
a pause command;
a fast-forward command;
a replay command;
a skip command; or
a rewind command; and
wherein the second playback signal is executable on the plurality of digital video devices to synchronize playback of the particular video content in a shared viewing environment that provides substantially simultaneous viewing of the particular video content on the plurality of digital video devices.

10. The content sharing system of claim 1, further comprising an audio communication device that are operably coupled to the playback synchronization component and provides substantially real-time audio communications between the user and other users of the disparately located digital video devices.

11. The content sharing system of claim 1, wherein the plurality of disparately located digital video devices comprises a plurality of disparately located digital video recording devices, the content sharing system further comprising:
a recording coordination component configured to control recording of the video content on each of the digital video recording devices by sending a record signal to each digital video recording device.

12. The content sharing system of claim 11, wherein the particular video content comprises at least one of a television program or a movie, and further comprising:
an artificial intelligence component configured to determine a manner of providing the particular video content to each of the digital video devices.

13. A computer-implemented method comprising:
receiving an indication of a content selection input from a user that selects a particular video content for viewing;
receiving an indication of a playback initiation input from the user to initiate synchronized playback of the particular video content across a plurality of disparately located digital video devices that communicate over a communication network;
based on the indication of the playback initiation input, sending a first playback signal to initiate the synchronized playback of the particular video content on each of the plurality of disparately located digital video devices;
during the synchronized playback of the particular video content, receiving an indication of a playback control input from the user;
based on the indication of the playback control input, sending a second playback signal to control the synchronized playback of the particular video content on each of the plurality of disparately located digital video devices;
obtain user-generated textual content that is not part of the particular video content; and
transmit the user-generated textual content for rendering on the plurality of disparately located digital video devices.

14. The computer-implemented method of claim 13, and further comprising:
receiving an indication of an input from the user; and
generating the user-generated textual content based on the indication of the input.

15. The computer-implemented method of claim 13, wherein the user-generated textual content comprises content about the particular video content, and wherein the user-generated textual content is transmitted over the communication network to the plurality of disparately located digital video devices for rendering during the synchronized playback.

16. The computer-implemented method of claim 13, wherein the second playback signal comprises at least one of:
a pause command;
a fast-forward command;
a replay command;
a skip command; or
a rewind command; and
wherein the second playback signal is executable on the plurality of digital video devices to synchronize playback of the particular video content in a shared viewing environment that provides substantially simultaneous viewing of the particular video content on the plurality of digital video devices.

17. A user computing system comprising:
a video presentation device;
a network communication interface configured to communicate with another computing system over a communication network, the other computing system being remote from the user computing system;
a processor;
memory storing instructions executable by the processor, wherein the instructions, when executed, configure the user computing system to:
receive a content selection user input from a user of the user computing system, wherein the content selection user input selects video content from a live broadcast scheduled to occur at a future time;
send, to the other computing system over the communication network, a record signal that instructs the other computing system to record the selected video content from the live broadcast at the future time;
receive a playback user input from the user; and
based on the playback user input, send a playback signal to the other computing device over the communication network to synchronize playback of the selected video content recorded on the other computing system with playback of the selected video content on the user computing system.

18. The user computing system of claim 17, wherein the playback user input comprises a playback initiation user input that initiates playback of the selected video content on both of the user computing system and the other computing system, and wherein the instructions configure the user computing system to:
during the synchronized playback of the selected video content,
receive a playback control user input from the user; and
in response to the playback control user input, send a playback control signal to the other computing system to control the synchronized playback of the selected video content, wherein the playback control signal comprises at least one of:
a pause command;
a fast-forward command;
a replay command;
a skip commercial command; or
a rewind command

19. The user computing system of claim 17, wherein the user computing system comprises a controlling personal video recorder and the other computing system comprises a controlled personal video recorder.

20. The user computing system of claim 17, wherein the instructions configure the user computing system to:
send, over the communication network, the record signal and playback signal to a plurality of other computing systems that are each remotely located from the user computing system.
